(19) United States
(12) Patent Application Publication
(10) Pub. No.: US 2006/0098014 A1
(43) Pub. Date: May 11, 2006

(54) Apparatus and method for generating digital character

(76) Inventors: Seong-Min Baek, Daejon (KR); Choon-Young Lee, Daejon (KR); In-Ho Lee, Daejon (KR); Hyun-Bin Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/193,116

(22) Filed: Jul. 29, 2005

(30) Foreign Application Priority Data
Nov. 5, 2004 (KR) 10-20040089860

(51) Int. Cl. G06T 15/70; G06T 13/00

(52) U.S. Cl. 345/474

(57) ABSTRACT

Provided are an apparatus for generating multiple digital characters that do not collide with each other and a method thereof. The apparatus includes a posture storing block for extracting and storing key postures from motion capture data provided from the outside and for calculating and storing connection relationship between the extracted key postures, a character generating block for producing virtual characters based on user-input parameters, a simulating block for simulating the virtual characters not to collide with each other and generating motion pattern parameters based on the simulation result, a key frame generating block for searching matched postures according to the motion pattern parameters, which are transmitted from the simulating block, after then, changing the virtual characters, and generating key frames by locating the changed characters in corresponding positions on the screen, and a motion file generating block for producing a motion file by interpolating the key frames.

### FIELD OF THE INVENTION

The present invention relates to an apparatus for generating digital characters and a method thereof; and, more particularly, to an apparatus and method for generating a multiplicity of digital characters automatically by using key postures extracted from motion capture data and information of connecting relationship between the key postures, and controlling paths or postures of the characters not to collide with each other, therefore, creating various and realistic scenes of a multitude used for animations, games, movies, and so on.

### DESCRIPTION OF THE RELATED ART

As the number of multitude scenes in animations, games, and movies increases, studies in generating 3D characters using computer graphics become popular.

Previous studies in 3D characters mainly focused on editing or controlling a single character to make its movement natural. In addition, a particle system and a method of preventing collision by using a simple object have been presented as the technology for multiple objects. However, those methods are not applicable to human movement.

Moreover, recently published papers provide various methods for generating and controlling multiple human-type characters according to action patterns. But, they still have limitations in terms of producing natural motions.

In particular, multiple 3D characters in movies or animations are essential for presenting natural scenes. And awkward motions of 3D characters degrade the quality of works of art (contents). Therefore, it is strongly required to find out how to generate multiple 3D characters, used for scenes of crowd people, and control the characters to move naturally and also intelligently.

### SUMMARY OF THE INVENTION

It is, therefore, an object of the present invention to provide an apparatus and method for generating a multiplicity of digital characters automatically by using key postures extracted from motion capture data and information of connecting relationship between the key postures, and controlling paths or postures of the characters not to collide with each other, therefore, creating various and realistic scenes of a multitude used for animations, games, movies, and so on.

In accordance with an aspect of the present invention, there is provided an apparatus for generating digital characters, which includes a posture storing block for extracting and storing key postures from motion capture data provided from the outside and for calculating and storing connection relationship between the extracted key postures, a character generating block for producing virtual characters based on user-input parameters, a simulating block for simulating the virtual characters not to collide with each other and generating motion pattern parameters based on the simulation result, a key frame generating block for searching matched postures according to the motion pattern parameters, which are transmitted from the simulating block, after then, changing the virtual characters, and generating key frames by locating the changed characters in corresponding positions on the screen, and a motion file generating block for producing a motion file by interpolating the key frames.

In accordance with another aspect of the present invention, there is provided a method for generating digital characters, which comprises the steps of storing key postures extracted from motion capture data and the connection relationship information between the extracted key postures, producing the digital characters based on user-input parameters, simulating the movement of the characters not to collide with each other and producing motion pattern parameters to control each character's motion, searching matched postures according to the motion pattern parameters, after then, changing the posture of each character by using the matched postures, and generating key frames by locating changed characters in corresponding positions on the screen, and interpolating a middle frame between the key frames in order to produce the motion file.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram of an apparatus for generating digital characters in accordance with the present invention;

FIG. 2 describes a detailed block diagram of a motion simulation block in FIG. 1;

FIG. 3 shows a detailed block diagram of a motion control block in FIG. 1;

FIG. 4 depicts a detailed block diagram of a posture storing block in FIG. 1;

FIG. 5 illustrates a process of generating a new posture by interpolating a multiplicity of key postures in accordance with the present invention; and

FIG. 6 presents a flowchart of explaining a method for generating digital characters in accordance with the present invention.

### DETAILED DESCRIPTION OF THE INVENTION

Other objects and aspects of the invention will become apparent from the following description of the embodiments with reference to the accompanying drawings, which is set forth hereinafter.

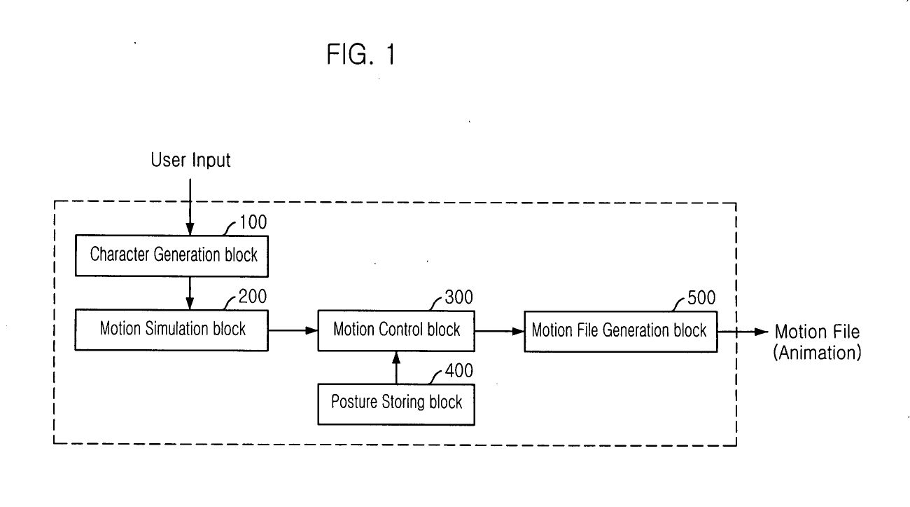

FIG. 1 shows a block diagram of an apparatus for generating digital characters.

Referring to FIG. 1, the inventive apparatus includes a posture storing block 400 for extracting and storing key postures from motion capture data provided from the outside, and calculating and storing the connecting relationship between the extracted key postures, a character generation block 100 for generating virtual characters based on user input parameters, a motion simulation block 200 for simulating motion of characters generated at the character generation block 100 to make the characters move without colliding with each other and generating motion pattern parameters of the characters, a motion control block 300 for changing the characters generated at the character generation block 100 by searching matched postures in the posture storing block 400 according to the motion pattern parameters generated at the motion simulation block 200, thereby locating changed characters in an appropriate position on a screen to generate a key fame, and a motion file generation block 500 for producing a motion file(animation) by interpolating the key frame generated at the motion control block 300.

The character generation block 100 produces a virtual character having a certain number of articulations (for example, 23) based on user input parameters (the number of characters, position, direction, status of arrangement, force, Health Power, belonging group, enemy).

Meanwhile, an initial posture of the character forms a ‘T’ shape for easy connection of skin mesh. The position of each character is determined not to collide with each other in a region designated by a user. For this, each character has two collision regions to avoid collisions and a collision anticipation region to predict prospect collisions. These two collision regions are the sphere-shaped outer and inner space respectively.

The motion simulation block 200 simulates the produced characters not to collide with each other and transmits their motion pattern parameters, which are generated by simulation results, to the motion control block 300. The motion pattern parameters are used to control the motion of each character.

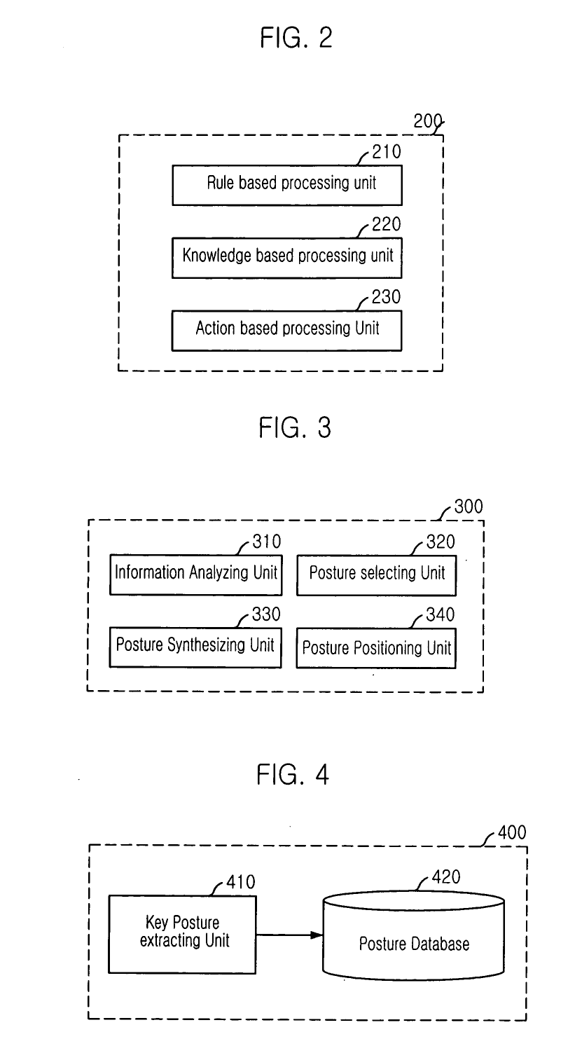

Referring to FIG. 2, the motion simulation block 200 contains a rule based processing unit 210, a knowledge based processing unit 220, and an action based processing unit 230.

The knowledge based processing unit 220 manages environmental information such as positions and directions of other nearby characters and obstacles in order to avoid collisions. The detail information is so-called “Knowledge”. In accordance with the present invention, the “Knowledge” includes global information for determining an overall path and local information for generating a track without collision.

That is, the global information contains initial location, final location, and information about fixed objects. The local information contains information about fixed objects or moving objects on the path.

In the mean time, the rule based processing unit 210 utilizes the environmental information, which is managed by the knowledge based processing unit 220, thereby predicting whether a character moving in current velocity and direction will collide or not. And then, if there is no possibility to collide, the character continues to move in the same velocity and direction. On the other hand, if collision is predicted, the velocity and direction of the character is adjusted based on predefined rules.

In the rule based processing unit 210, the collision avoidance rules define the following cases.

1. If two characters move facing to each other, the characters take actions to avoid collision in advance at far ahead location from the position where collision is anticipated. That is, in case of finding safe positions, they change their directions to left or right in order to avoid collision. If it fails to find safe positions, they check whether it is possible to avoid collisions by bending their upper parts of bodies.

2. In case of outrunning other characters, it is required to select a safe space in advance, and then, pass the other characters. At the same time, it is checked whether it is necessary to change the direction of whole body or not. 3. When collision is anticipated, it is required to increase or decrease speed, wait until the other objects pass by, or change the direction itself.

As described above, by using information of the knowledge based processing unit 220, the rule based processing unit 210 simulates the characters produced at the character generation block 100 to make the characters move not to collide with each other and controls their directions and velocities based on the predefined rules.

Meanwhile, in case of controlling the direction and velocity, there should be considered positions, directions, and velocities of other characters or obstacles. If there is a large surrounding space, the collision is avoided by controlling the direction or velocity without consideration of an outer space or inner space. If there is a normal surrounding space, the collision is avoided by using an outer large space. If there is a small surrounding space, the collision is avoided by using an inner space. In case that the surrounding space is too small to avoid the collision, it is required to change a pose (changing articulations), for example, by twisting an upper body part to the left or right.

As a result, the rule based processing unit 210 simulates the characters not to collide with each other by controlling their locations, directions, velocities, and articulations (posture). And in accordance with the control results, the rule based processing unit 210 requests the action based processing unit 230 to change the motion pattern parameters.

The action based processing unit 230 sets the motion pattern parameters under the control of the rule based processing unit 210, and then, determines how to prevent collisions by controlling features of a group (multiple characters in the group) or an individual (each character) in a crowd, twisting its upper body part, or changing its whole position.

The motion pattern parameters can be implemented as follows.

- Velocity Control

Fast_Group
Normal_Group
Slow_Group

- Collision Avoidance

Collision_Level_All
Collision_Levet_UpperBody

> Left_Turn
> Right_Turn

...

The motion control block 300 searches a matched posture in the posture storing block 400 according to the motion pattern parameters transmitted from the motion simulation block 200, changes the character, which is generated at the character generation block 100, into the matched posture, then, and locates the changed character in a corresponding position, thereby creating a key frame.

For this, as described in FIG. 3, the motion control block 300 contains an information analyzing unit 310 for analyzing the motion pattern parameters transmitted from the motion simulation block 200, an posture selecting unit 320 for selecting corresponding key postures from the posture storing block 400 according to the analyzed result from the information analyzing unit 310, an posture synthesizing unit 330 for interpolating the key postures selected at the posture selecting unit 320 to create one new multi-layered posture, and a posture positioning unit 340 for changing the character generated at the character generation block 100 based on the key postures selected at the posture selecting unit 320 or the multi-layered posture generated at the posture synthesizing unit 330, and, after that, locates the character in the corresponding position on the screen according to the motion pattern parameters (simulated path), which are analyzed in the information analyzing unit 310.

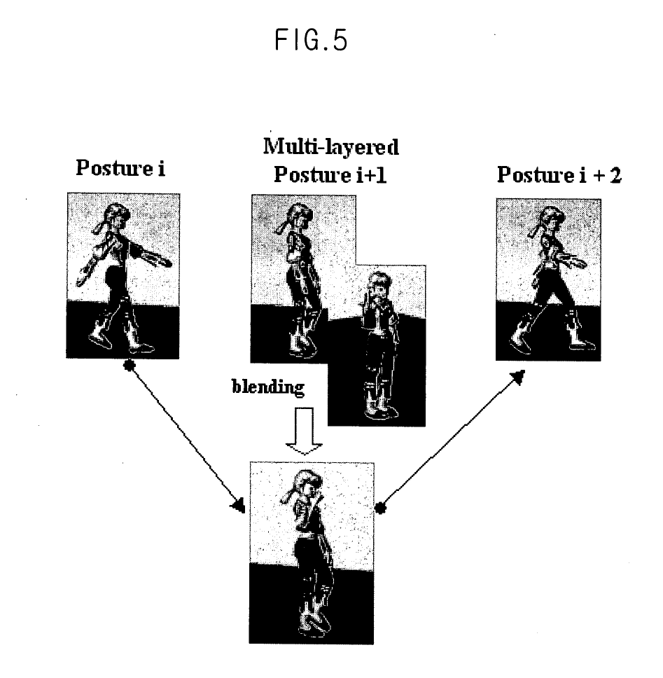

Referring to FIG. 5, the multi-layered posture is made by interpolating the key postures selected at the posture selecting unit 320. For example, a posture of raising one hand while walking 53 is made by synthesizing a walking posture 51 and a posture of raising one hand 52.

In addition, in case of locating the characters, which are changed by using the key postures selected at the posture selecting unit 320 or the multi-layered posture created at the posture synthesizing unit 330, along the simulation path, their positions of feet touching the ground are consistent with each other by using the center of gravity and restriction of feet. Their posture directions are consistent to a tangent line of the path.

In the mean time, the posture storing block 400 stores therein the key postures extracted from the motion capture data and the connection relationship between the extracted key postures.

That is, as shown in FIG. 4, the posture storing block 400 has a key posture extracting unit 410 for extracting the key postures from the motion capture data inputted from the outside and a posture database 420 for storing the key postures under the control of the key posture extracting unit 410 and the connection relationship between the key postures.

In this case, the motion capture data are obtained by capturing human motion directly and, thus, its motion is similar to that of the human. However, since the data size is large, a long time will be needed for pre-processing the data to find out the connection relationship. Therefore, to solve this problem, the motion capture data are classified according to basic motions described in [Table 1] and then key postures are extracted from [Table 1].

TABLE 1

| Basic | Upper level | |
|---|---|---|
| motion | extraction | Lower level extraction |
| Motion | Walking | The posture at the moment of two |
| Capture | | feet on the ground (left foot behind) |
| Data | | The posture at the moment of two |
| | | feet on the ground (left foot front) |
| | | The posture at the moment of a left |
| | | foot crossing over a right foot |
| | | The posture at the moment of a right |
| | | foot crossing over a left foot |
| | | . . . |
| | Waving hands | Initial posture (dangling arms) |
| | | The posture of raising hands (medium |
| | | level) |
| | | The posture of raising hands (maximum |
| | | level) |
| | Jump | Jumping level 1 |
| | | . . . |
| | | The posture at the moment of taking- |
| | | off the ground |
| | | The posture in the highest position |
| | | The posture of reaching the ground |
| | . . . | . . . |

As described above, the key posture extracting unit 410 extracts parameters such as velocity, action status and foot restriction, as well as the key postures from the motion capture data.

Meanwhile, the key postures extracted from the motion capture data should be able to reconstruct original motion according to their connection relationship.

The connection relationship is obtained by calculating relations between the key postures extracted from the motion capture data. It is an important factor to determine how to generate natural motion change from a current posture to the next posture. An equation EQ. 1 shows how to calculate the connection relationship.

$$\begin{matrix}\hat{r} ( t ) = \frac{A}{2} Δ {t}^{2} + r , & \hat{x} ( t ) = x ( {t}_{c} ) + v ( {t}_{c} ) Δ t , & Δ t = \frac{2 {R}_{d}}{( {v}_{ri} + {v}_{rj} )}\end{matrix} \\ \begin{matrix}{\overline{d}}_{ij} = \vert \frac{\hat{x} ( t ) - {x}_{j}}{\hat{r}} \vert , & p ( {\overline{d}}_{ij} ) = \{ \begin{matrix}2 {\overline{d}}_{ij}^{3} - 3 {\overline{d}}_{ij}^{2} + 1 , & if {d}_{ij} < 1 \\ 0 , & otherwise\end{matrix}\end{matrix} \qquad [ EQ . 1 ]$$

In this equation, important parameters are the position of feet, direction, and velocity. In order to connect to the next posture, the foot on the ground should be the same. And, as the moving foot locates closer to the center of a next movement region of the moving foot, a value of the connection relationship gets closer to ‘1’ and, otherwise, it gets closer to ‘0’.

As described above, the posture storing block 400 extracts and stores the key postures. Before generating the scene of a crowd, the process of calculating the connection relationship between the key postures and storing the results should be performed in advance. Once the key postures and the connection relationship are stored, they can be reusable continuously. After then, the motion control block 300 compares the posture of each character at every frame rather than its motion and, therefore, the processing speed is increased.

The motion file generation block 500 interpolates the posture of each character at each frame. That is, the motion file generation block 500 interpolates a middle frame between two key frames to produce the motion file (animation). In this case, because the key posture can be reconstructed from the motion capture data, the quality of animation created by interpolation is similar to the quality of the motion capture data. And, in case of interpolating each key posture, a spline quaternion interpolation method is used.

In addition, using retargeting method, the motion file generation block 500 adjusts minutely the motion file (animation) in order that the character does not fall down the ground or slip down.

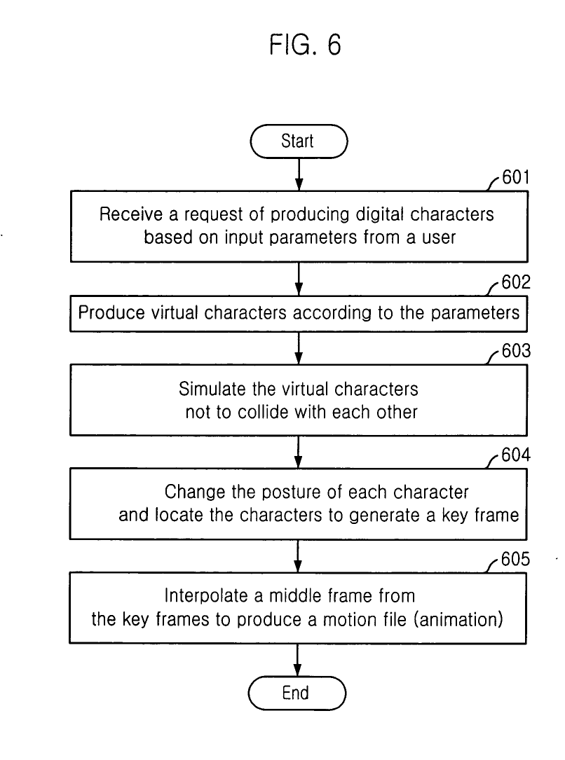

Referring to FIG. 6, the overall process of the present invention can be explained.

FIG. 6 shows a flowchart of explaining a method for generating digital characters in accordance with the present invention.

At first, for operation, the key postures extracted from the motion capture data and the connection relationship between key postures should be stored in the posture database.

After then, in step S601, a request of producing the digital characters is received based on user-input parameters such as the number of characters, initial position, direction, arrangement state, force, and so on.

Then, in step S602, according to the user-input parameters (the number of characters, initial position, direction, arrangement state, force, etc.), there are created virtual characters having a certain number (for example, 23) of articulates.

And, in step S603, motion pattern parameters to control each character's motion are generated by simulating the virtual characters not to collide with each other.

In step S604, according to the motion pattern parameters, matched postures are searched from the posture database and, after then, key frames are produced by changing the posture of each character based on the matched postures and locating the changed character in a corresponding position.

In step S605, the motion file (animation) is finally generated by interpolating a middle frame between the key frames.

As described above, the method in accordance with the present invention can be implemented as a S/W program and stored in recorded media (CD ROM, RAM, ROM, Floppy disk, HDD, magneto-optical disk, etc.) in a computer readable format.

The present invention makes it easy to generate digital characters. It is effective to produce realistic animation, especially various and realistic scene of a multitude (crowd of people).

On account of generating multiple characters which are various and realistic, as a result, the present invention can improve productivity and contribute to the convenience of the production of contents industry (movie, animation, game, etc.)

The present application contains subject matter related to Korean patent application No. 2004-0089860, filed with the Korean Intellectual Property Office on Nov. 5, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for generating digital characters comprising:
a posture storing means for extracting and storing key postures from motion capture data provided from the outside and for calculating and storing connection relationship between the extracted key postures;
a character generating means for producing virtual characters based on user-input parameters;
a simulating means for simulating the virtual characters not to collide with each other and generating motion pattern parameters based on the simulation result;
a key frame generating means for searching matched postures according to the motion pattern parameters, which are transmitted from the simulating means, after then, changing the virtual characters, and generating key frames by locating the changed characters in corresponding positions on the screen; and
a motion file generating means for producing a motion file by interpolating the key frames.

2. The apparatus as recited in claim 1, wherein the posture storing means extracts the key postures as well as parameters such as velocity, action state, foot restriction and so on after classifying the motion capture data according to a basic operation.

3. The apparatus as recited in claim 2, wherein the key postures extracted by the posture storing means can be reconstructed to an original motion according to the connection relationship.

4. The apparatus as recited in claim 1, wherein the character generating means generates the virtual characters having a certain number of articulations based on the user-input parameters, initial postures of the characters forming a ‘T’ shape for easy connection of skin mesh and the position of each character determined not to collide with each other in a region designated by a user.

5. The apparatus as recited in claim 4, wherein the user-input parameters contains the number of characters, initial positions, directions and arrangement states.

6. The apparatus as recited in claim 1, wherein each character generated at the character generating means contains two collision regions, which have a sphere-shaped large outer and small inner space, respectively, in order to prevent collisions, and a collision anticipation region to predict prospect collisions.

7. The apparatus as recited in claim 1, wherein the simulating means includes:
a knowledge based processing means for managing information for obstacles and positions and directions of other nearby characters in order to prevent collisions effectively;
a rule based processing means for simulating the virtual characters produced at the character generation means not to collide with each other and controlling their directions and velocities based on predefined rules by using the information of the knowledge based processing means; and
an action based processing means for producing the motion pattern parameters under the control of the rule based processing means, and then, controlling features of a group (multiple characters in groups) or an individual (each character) to avoid collisions with each other.

8. The apparatus as recited in claim 7, wherein the rule based processing means simulates the virtual characters produced at the character generation means not to collide with each other and controlling their locations, directions, velocities, or articulations based on the predefined rules by using the information of the knowledge based processing means.

9. The apparatus as recited in claim 8, wherein, in order to control the locations, directions, velocities, or articulations, the rule based processing means performs the control process based on locations, directions, and velocities of other characters or obstacles, avoids collisions by controlling the directions or velocities according to nearby spaces, and avoids collisions by controlling the articulations in case that the nearby spaces are too small to avoid collisions.

10. The apparatus as recited in claim 1, wherein the key frame generating means includes:
an analyzing means for analyzing the motion pattern parameters transmitted from the motion simulation means;
a posture selecting means for selecting corresponding key postures from the posture storing means according to the analyzing result of the information analyzing means; and
a posture positioning means for changing the characters generated at the character generation means in accordance with the key postures selected by the posture selecting means and, then, locating the changed characters in corresponding positions on the screen according to the motion pattern parameters, which are analyzed at the analyzing means, to thereby produce the key frames.

11. The apparatus as recited in claim 10, wherein the key frame generating means further includes:
a posture synthesizing means for interpolating the key postures selected by the posture selecting means to create one new multi-layered posture.

12. The apparatus as recited in claim 11, wherein the posture positioning means changes the virtual characters generated at the character generation means and locates the changed characters in the corresponding positions on the screen according to the motion pattern parameters, which are analyzed by the analyzing means, to thereby create the key frames, the characters having feet touching the ground whose positions are consistent with each other according to the center of gravity and restriction of foot and the postures of the characters being consistent with a tangent line of their moving path.

13. The apparatus as recited in any one of claims 1 to 3, wherein the motion file generation means interpolates the posture of each character, which is included in each key frame, and creates the motion file by using a spline quaternion interpolation method.

14. The apparatus as recited in claim 13, wherein the motion file generating means adjusts minutely the motion file in order that each character does not fall down the ground or slip down by using a retargeting method.

15. A method for generating digital characters, which comprises the steps of:
storing key postures extracted from motion capture data and the connection relationship information between the extracted key postures;
producing the digital characters based on user-input parameters;
simulating the movement of the characters not to collide with each other and producing motion pattern parameters to control each character's motion;
searching matched postures according to the motion pattern parameters, after then, changing the posture of each character by using the matched postures, and generating key frames by locating changed characters in corresponding positions on the screen; and
interpolating a middle frame between the key frames in order to produce the motion file.
